(19) United States
(12) Patent Application Publication
(10) Pub. No.: US 2009/0314316 A1
(43) Pub. Date: Dec. 24, 2009

(54) Steam Cleaner

(76) Inventor: David R. Hall, Provo, UT (US)

Correspondence Address: TYSON J. WILDE;NOVATEK INTERNATIONAL, INC., 2185 SOUTH LARSEN PARKWAY, PROVO, UT, 84606, US

(21) Appl. No.: 12/145,149

(22) Filed: Jun. 24, 2008

(51) Int. Cl. B08B 13/00

(52) U.S. Cl. 134/198

(57) ABSTRACT

A steam cleaning apparatus comprises a chamber with at least one holder. A plurality of nozzles is incorporated in the holder and is adapted to disperse steam within the chamber.

### BACKGROUND OF THE INVENTION

The present invention relates to steam cleaning. Steam cleaning has been known in the art as illustrated by the following references.

U.S. Pat. No. 3,477,645 to Spangler, Jr. et al., which is herein incorporated by reference for all that it contains, discloses a miniature hand-held boiler heated by a disposable pyrotechnic cartridge that can be connected to an ordinary garden hose. Water can be fed through the hollow handle directly into the boiler in substantial volume to be heated or, alternatively, it can be sprayed therein and converted to steam. The gases evolved from the burning pyrotechnic device are mixed with the steam in the spray nozzle to impart additional energy to the latter. Means are also provided for admitting water from the boiler into the cartridge chamber for the purpose of extinguishing the pyrotechnic device.

U.S. Pat. No. 6,129,097 to Papandrea, which is herein incorporated by reference for all that it contains, discloses a jewelry cleaning device comprising a neck portion and a body portion each formed by a wall of fine, flexible mesh material which collectively define a hollow interior having an open top in the neck portion and a closed bottom in the body portion. A support located at the open top of the neck portion is effective to mount the device to the steam pipe of a steam cleaning device so that the nozzle at the end of the steam pipe extends into the hollow interior. The body portion is formed with an access opening fitted with a closure device which is movable between an open position to permit the insert of an item of jewelry within the hollow interior, and a closed position wherein the access opening is substantially closed against the tweezers or other gripping device used to hold the jewelry item during the steam cleaning operation.

U.S. Pat. No. 4,135,531 to Federighi, which is herein incorporated by reference for all that it contains, discloses a dishwasher that has a steam boiler containing hot water and steam under pressure. The dishwasher has a dishwashing and rinsing compartment with a body of hot water, adjustable as to depth, received in the bottom of the compartment. A time controlled device delivers steam from the boiler to steam jets in the compartment for a predetermined time period for washing the dishes. The steam jets have apparatus associated therewith that will cause the steam jets to periodically entrain hot water from the body of water to deliver a pulsating steam and hot water action against the dishes for washing them. The depth of the body of water can be raised so that only live steam and water will issue from the steam jets if desired, with no pulsating action. The time controlled device delivers hot rinse water from the boiler for rinsing the dishes in the compartment after the dishwashing operation.

U.S. Patent No. 2002/0078977 A1 to Manne, which is herein incorporated by reference for all that it contains, discloses a preliminary steaming step that employs before a conventional dishwashing operation. The preliminary steaming step is conducted for 15-20 minutes, at a temperature of 100-150° C., and a pressure of 15 psi.

### BRIEF SUMMARY OF THE INVENTION

A steam cleaning apparatus comprises a chamber with at least one holder. A plurality of nozzles is incorporated in the holder and is adapted to disperse steam within the chamber.

The steam cleaning apparatus may be incorporated into a table, a drawer, a cabinet, a dishwasher, or a combination thereof. The steam cleaning apparatus may be able to be elevated and lowered from within the table. The holder may be adapted to angle objects in a direction of the steam. The chamber may comprise a ventilation system adapted to remove the steam from the chamber. The steam cleaning apparatus may be in communication with a housing adapted to hold water and deliver the water to a pump. The housing may be in communication with a generator adapted to turn the water into steam. The generator may be in communication with a natural gas tank. The nozzles may be incorporated in a wall of the chamber. The nozzles may also be adapted to disperse air after dispersing steam. At least one of the plurality of nozzles may be a fluidic nozzle. The steam may comprise a temperature of 318 degrees Fahrenheit or more. The nozzles may disperse steam in a first direction first and then a second direction. The steam may disperse in the first and second direction for 3-10 seconds. The steam may disperse on an object short enough such that the object may be able to return to room temperature within 5 minutes. The steam may be dispersed continuously. The steam may also be pulsed. The steam may comprise a density of 0.19911304 g/ml or less.

In another aspect of the invention the chamber may be in communication with a centralized heated and pressurized water circulation system within a building and a valve that may control the amount of fluid that reaches the nozzles. The nozzles and the pressure associated with the water circulation system may create steam out of the fluid.

### BRIEF DESCRIPTION OF THE DRAWINGS

FIG. 1 is a perspective cross-sectional diagram of an embodiment of a steam cleaning system incorporated into a housing unit.

FIG. 2 is a cross-sectional diagram of an embodiment of a steam cleaning apparatus incorporated into a table.

FIG. 3 is another cross-sectional diagram of embodiment of a steam cleaning apparatus.

FIGS. 4a-4b are cross-sectional diagrams of embodiments of a steam cleaning apparatus.

FIG. 5 is perspective diagram of an embodiment of a portion of a steam cleaning apparatus.

FIG. 6 is perspective diagram of embodiment of a steam cleaning apparatus.

FIG. 7 is a perspective diagram of an embodiment of a steam cleaning apparatus.

FIG. 8 is a perspective diagram of a steam cleaning apparatus incorporated into a table.

FIG. 9 is another perspective diagram of an embodiment of a steam cleaning apparatus.

### DETAILED DESCRIPTION OF THE INVENTION AND THE PREFERRED EMBODIMENT

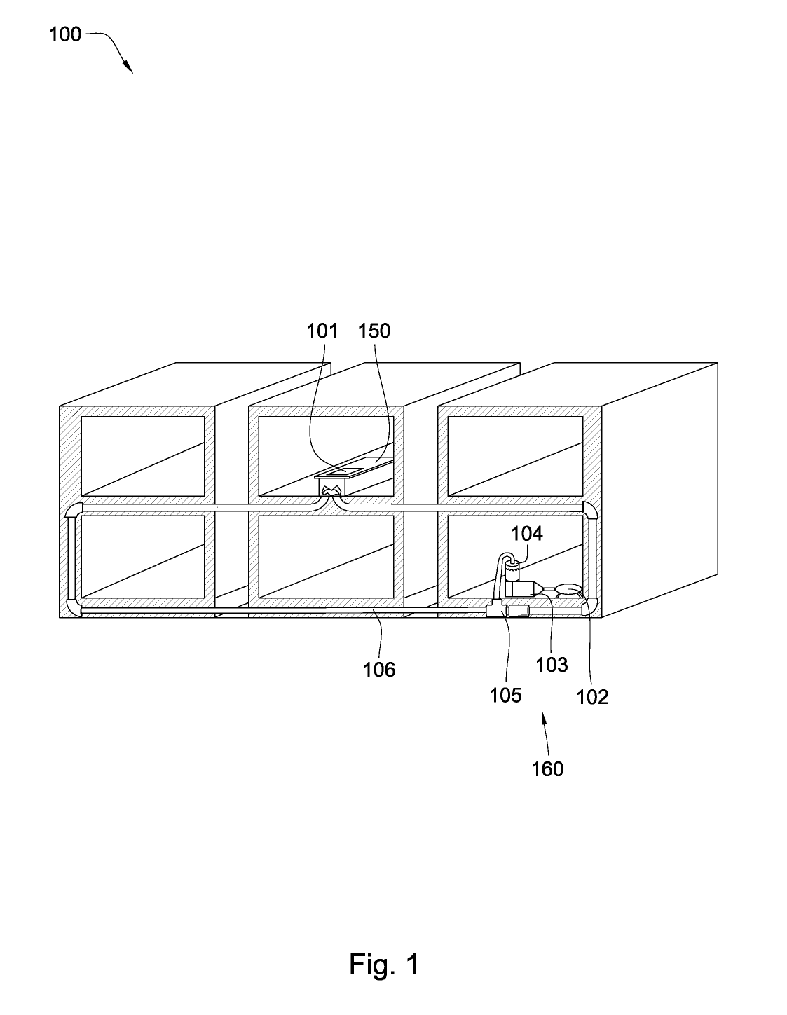

FIG. 1 is a perspective diagram of an embodiment of a plurality of housing units 100. The housing units 100 may comprise a steam cleaning apparatus 101 adapted to clean various objects such as dishes. The steam cleaning apparatus 101 may be incorporated into a table 150 and may maximize the usage of space. The steam cleaning apparatus 101 may be in communication with a pipe 106 that may be in communication with a pump 105. The pipe 106 may run throughout the housing unit 100 and may be a part of a centralized heated and pressurized water circulation system 160 within the housing unit 100. The water circulation system 160 may further comprise a tank 104 that may be in communication with the pump 105. The tank 104 may also be in communication with a generator 103 adapted to heat the tank 104 and convert the water into steam 290. The generator may produce heat by way of natural gas and may be in communication with a housing 102 that comprises natural gas.

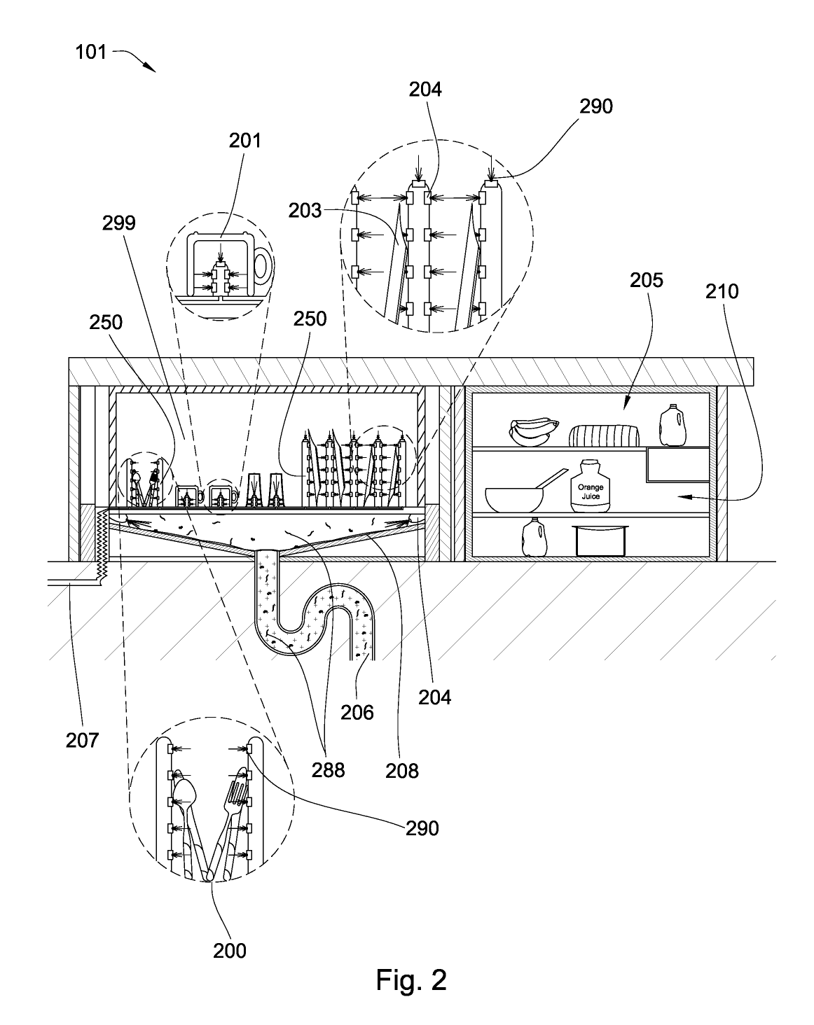

FIG. 2 is a perspective diagram of an embodiment of a steam cleaning apparatus 101. The steam cleaning apparatus 101 may be incorporated into a table 150. Instead of a separate cleaning apparatus and table 150 they may be combined for more efficient use of space. One may use the table 150 to dine as well as wash objects such as dishes by the use of steam 290. When more surface area is needed on the table 150 one may simply lower the steam cleaning apparatus 101 back into the table 150. When dishes are needed the steam cleaning apparatus 101 may elevate exposing dishes at a reachable distance. The cleaning apparatus may dual as space for storing dishes. The steam cleaning apparatus 101 may comprise one or a plurality of holders 250 adapted to hold objects such as dishes. The holder 250 may comprise a plurality of nozzles 204 adapted to disperse steam 290 towards the objects. The holder 250 may be perforated or comprise wire to allow debris and steam 290 to move toward a drain 208, and may be disposed within a chamber 299. The holder 250 may also be designed such that they angle dishes that they may be preferentially exposed to the steam 290. The holder 250 may be adapted to hold objects such as dishes like cups 201, plates 203, and eating utensils 200. A steam cleaning process in the apparatus is believed to be much quicker than a standard dishwasher, more energy efficient, and conserve water as well. The steam 290 may be greater than 318 degrees Fahrenheit. The steam may comprise a density of 0.1991304 or g/ml or less. The temperature of the steam 290 is believed to be enough to melt debris from objects without changing the composition of the object themselves. The cleaning process may comprise a duration of 3 to 10 seconds which is considerably less time compared to a standard dishwashing cycle. The steam cleaning apparatus 101 may also comprise a tapered floor with a drain 208 that leads to a drain pipe 206. Debris 288 from dirty objects may be directed to the drain pipe 206 by additional nozzles 204 dispersing steam 290 towards the drain pipe 206. The steam 290 may disperse such that the temperature of the objects returns to room temperature within five minutes of the steam cleaning process ending, preferably within a minute. The steam 290 may be dispersed continuously from all nozzles 204 or the steam 290 may be pulsated. The drain 208 may comprise a garbage disposal to facilitate drainage of debris 288. In some embodiments, the ground debris from the garbage may be stored in a bag and removed manually later. The table 150 may also comprise a compartment for a refrigerator 210 that may comprise food 205. Combining such appliances is believed to maximize space and may be advantageous for small residual living spaces.

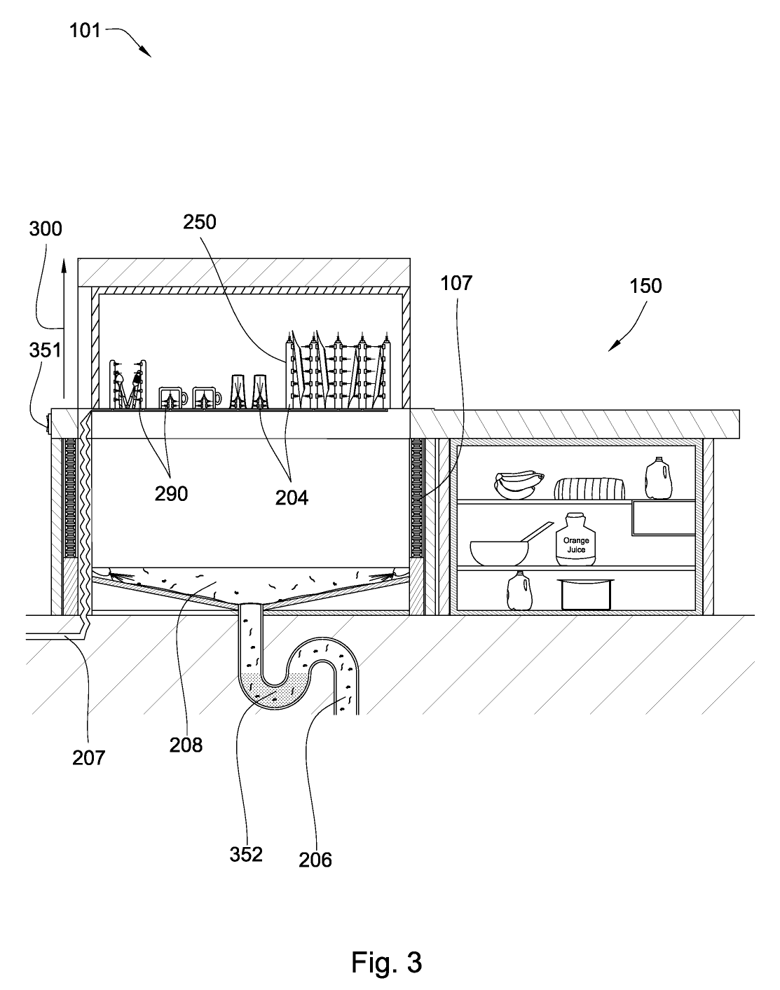

FIG. 3 is a perspective diagram of another embodiment of a steam cleaning apparatus 101. The steam cleaning apparatus 101 may be adapted to be elevated in the direction of the arrow 300 and may facilitate access to objects such as dishes. The steam cleaning apparatus 101 may elevate and lower by way of a rack and pinion 107 or with electronic devices. The rack and pinion 107 may be in communication with at least one switch 351 adapted to activate the steam cleaning apparatus 101 and lower or elevate it. The drain 208 may be fixed to the floor of the table 150 or may elevate as well. The holder 250 of the steaming cleaning apparatus may be in communication with a hose 207 adapted to carry steam 290. The hose 207 may comprise an elastomeric material adapted to elevate and lower with the holder 250. The drain pipe 206 may comprise standing water 352 that may prevent smells from coming through the drain pipe 206.

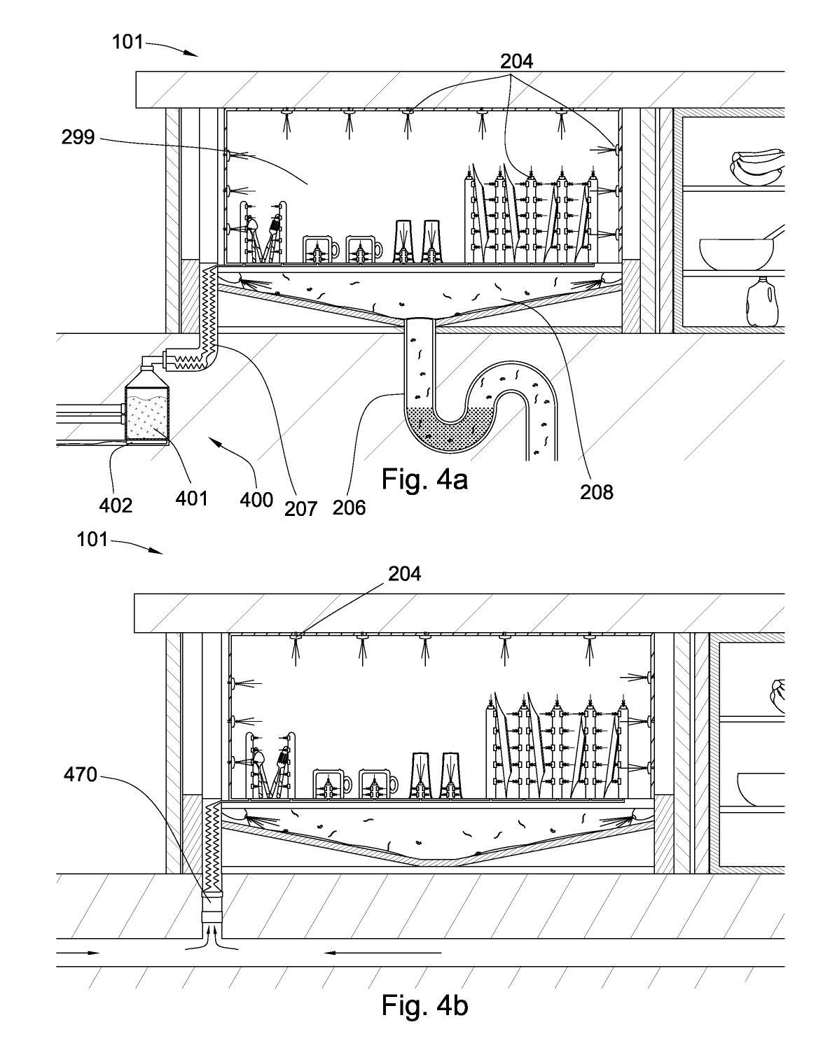

FIG. 4 is a perspective diagram of another embodiment of a steam cleaning apparatus 101. The steam cleaning apparatus 101 may comprise a chamber 299 with a plurality of nozzles 204. The nozzles 204 may be disposed such that debris is directed toward a drain for disposal. Steam 290 may be dispersed in a first direction and then in a second direction. The first direction of steam 290 may be adapted to generally clean the objects located within the apparatus 101. The first direction of steaming may also be adapted to deposit the debris in a general location such as downward and along one of the walls within the cleaning apparatus towards the drain 208. The second direction of steam 290 may be adapted to direct the deposited debris towards the drain pipe 206. In some embodiments, more than one direction of steaming may be used to clean the objects, since some objects and/or dishes may have complicated geometries where multiple directions of steaming may more efficiently clean all of their surfaces. The nozzles 204 may be disposed on interior walls of the steam cleaning apparatus 101. It is believed that such an arrangement of nozzles 204 steam 290 may reach the objects within the chamber 299. The nozzles 204 may be in communication with a hose 207 that may be adapted to move with the nozzles 204. The hose 207 may be in communication with a steam creating system 400. The steam system 400 may comprise an electric component 402 adapted to heat water 401 to high temperatures. In FIG. 4b the steam cleaning apparatus 101 comprises a valve 470 that may control the amount of fluid that reaches nozzles 204 of the steam cleaning apparatus 101.

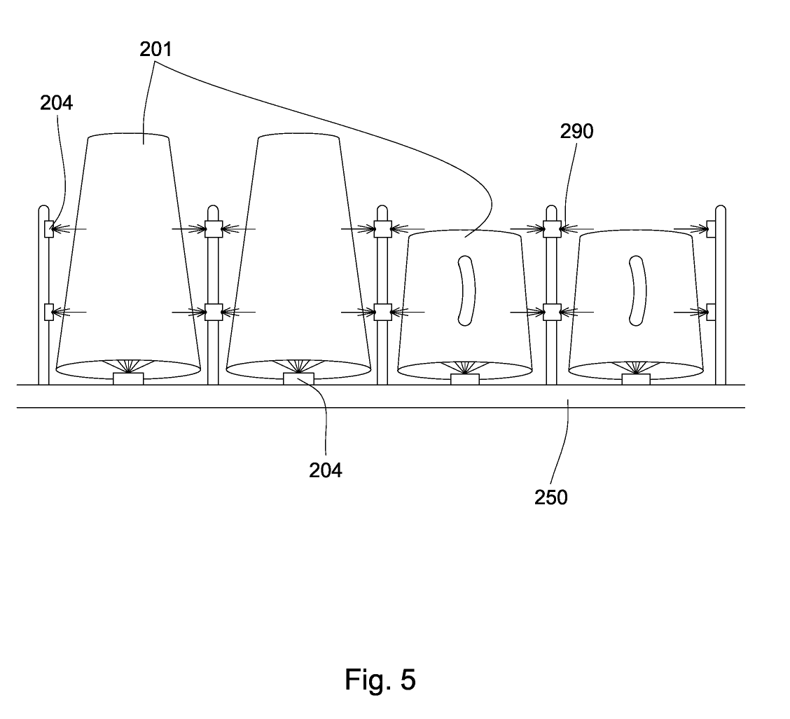

FIG. 5 is a perspective diagram of a holder 250 of a steam cleaning apparatus 101. The holder 250 of the steam cleaning apparatus 101 may be adapted to keep objects such as cups 201 in place. The holder 250 may comprise a plurality of nozzles 204 adapted to disperse steam 290. Such an arrangement may accommodate the complex geometry of objects such as cups and ensure that the steam 290 reaches the surfaces of the cup. The nozzles 204 may disperse steam 290 in various directions.

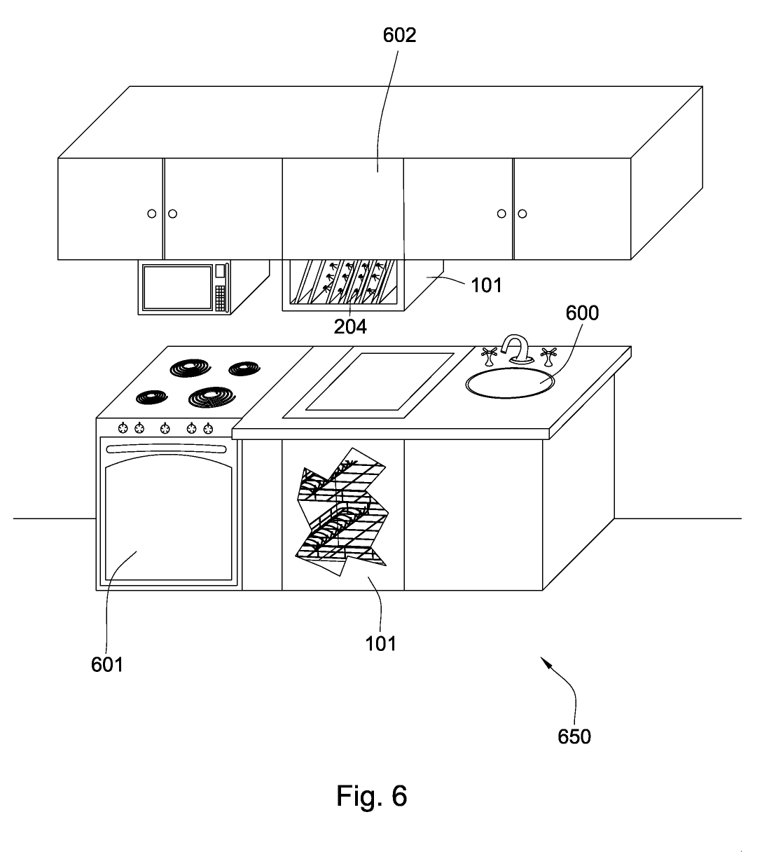

FIG. 6 is a perspective diagram of a plurality of steam cleaning apparatuses 101. The steam cleaning apparatus 101 may be incorporated into a counter 650 near a sink 600 or in a cabinet 602. The steam cleaning apparatus 101 may be near a stove 601 and may comprise useful utensils for cooking. After usage the object may be placed back into the steam cleaning apparatus 101 for cleaning and storage.

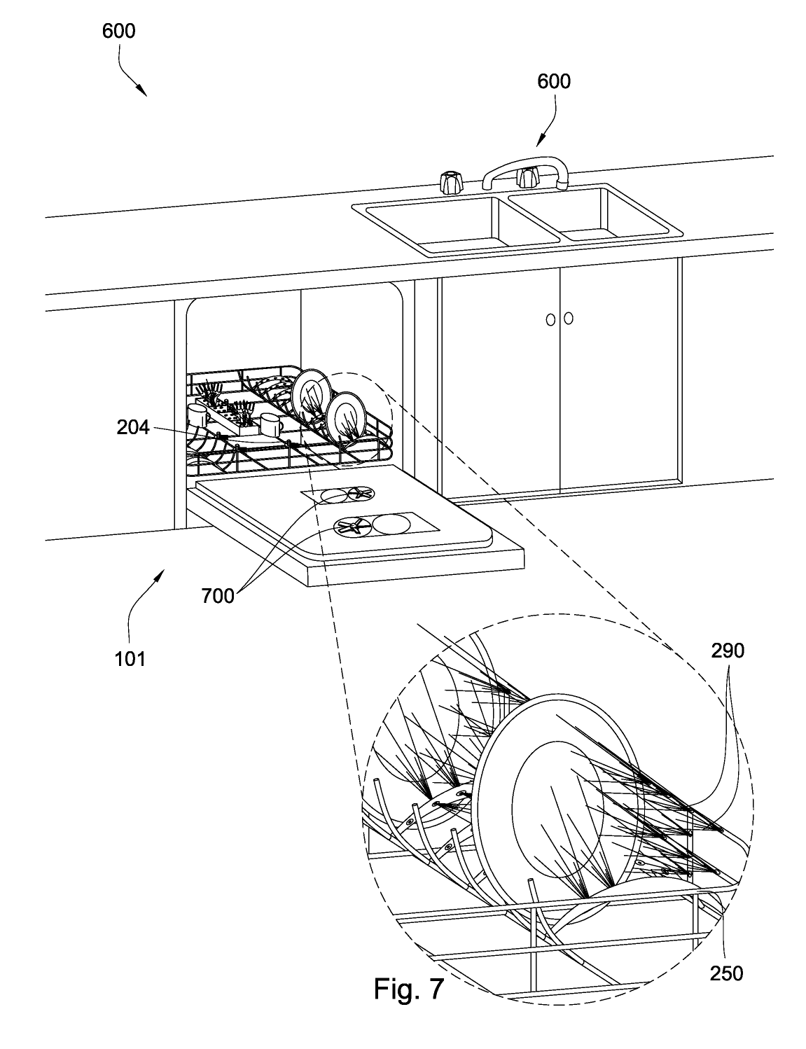

FIG. 7 is another perspective diagram of an embodiment of a steam cleaning apparatus 101. The steam cleaning apparatus 101 may be incorporated into a more traditional dishwasher in a standard counter. The steam cleaning apparatus 101 may comprise a ventilation system 700 adapted to lower the temperature of steam 290 or to remove the steam 290. During a steam cleaning process the fans may be covered by a lid. When the steam cleaning process is done the lids may retract and fans of the ventilation system 700 may activate. The steam 290 may exit through the drain or may be recycled to be used again. The steam 290 may be dispersed through nozzles 204 that may be disposed on the holder 250. The holder 250 may be adapted to hold specific objects, such as specific dishes in certain portions of the holder 250. In some embodiments, a low pressure outlet may also be incorporated into the cleaning chamber to aid in excess moisture removal.

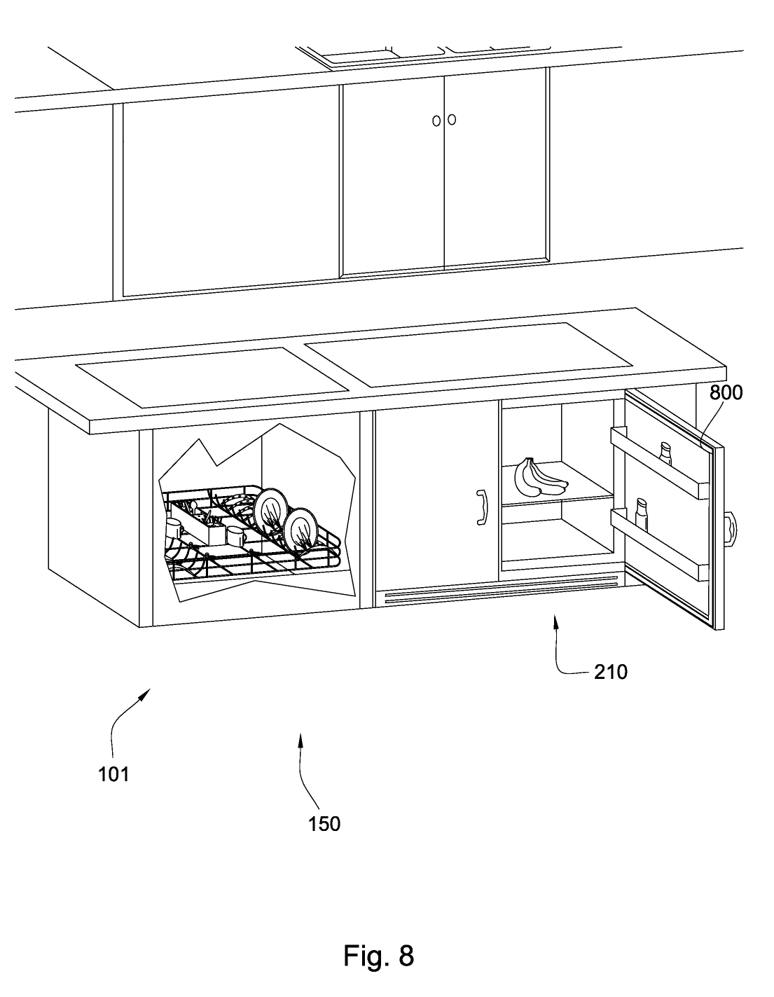

FIG. 8 is a perspective diagram of an embodiment of a steam cleaning apparatus 101. The steam cleaning apparatus 101 may be incorporated into a table 150 that may be in a central location. The table 150 may also comprise a refrigerator 210. Both the refrigerator 210 and the steam cleaning apparatus 101 may be adapted to elevate from within the table 150. The refrigerator 210 and steam cleaning apparatus 101 may also be accessible through a side door 800. Such an arrangement gives a user convenience in having food and dishes in one convenient place where the user may also dine.

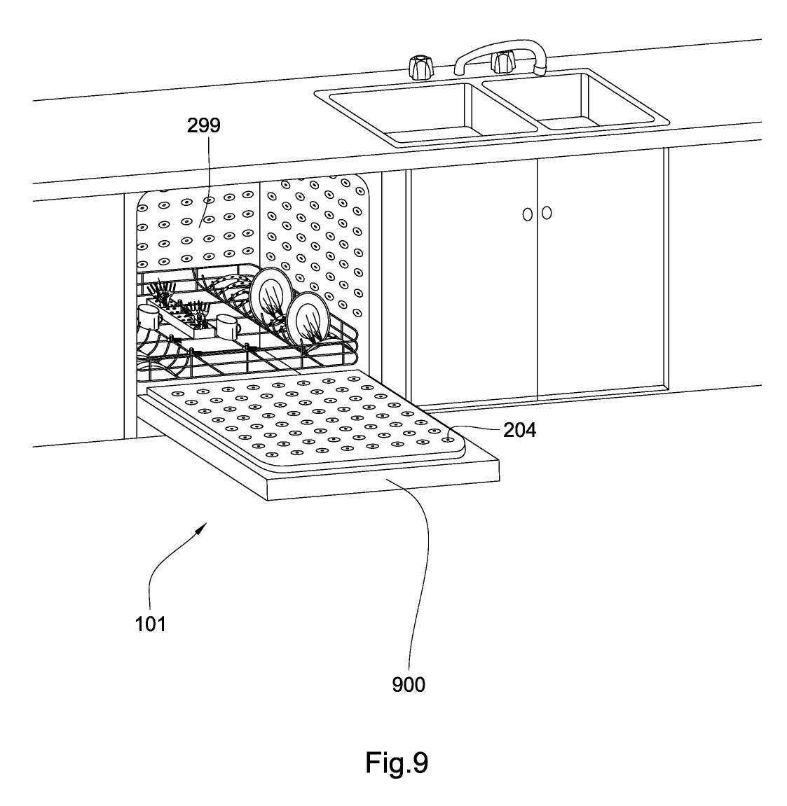

FIG. 9 is a perspective diagram of an embodiment of a steam cleaning apparatus 101. The steam cleaning apparatus 101 may comprise a plurality of nozzles 204 disposed in the holder 250 as well as on walls of the chamber 299. Nozzles 204 adapted to disperse steam 290 may also be disposed on a door 900 of the steam cleaning apparatus 101. Such an arrangement may ensure the steam 290 dispersed from the nozzles 204 reaches all objects within the chamber 299.

Whereas the present invention has been described in particular relation to the drawings attached hereto, it should be understood that other and further modifications apart from those shown or suggested herein, may be made within the scope and spirit of the present invention.

What is claimed is:

1. A steam cleaning apparatus, comprising;
a chamber with at least one holder;
a plurality of nozzles incorporated in the holder adapted to disperse steam within the chamber.

2. The apparatus of claim 1, wherein the steam cleaning apparatus is incorporated into a table, a drawer, a cabinet, or a combination thereof.

3. The apparatus of claim 2, wherein the holder is able to be elevated and lowered from within the table.

4. The apparatus of claim 1, wherein the holder is adapted to angle objects in a direction of the steam.

5. The apparatus of claim 1, wherein the nozzles are incorporated in a wall of the chamber.

6. The apparatus of claim 1, wherein the apparatus is in communication with a housing adapted to hold water and deliver the water to a pump.

7. The apparatus of claim 6, wherein the housing is in communication with a generator adapted to turn the water into steam.

8. The apparatus of claim 7, wherein the generator is in communication with a natural gas tank.

9. The apparatus of claim 1, wherein the chamber comprises a ventilation system adapted to remove the steam from the chamber.

10. The apparatus of claim 1, wherein the nozzles are adapted to disperse air after dispersing steam.

11. The apparatus of claim 1, wherein the steam comprising a temperature of 318 degrees Fahrenheit or more.

12. The apparatus of claim 1, wherein at least one nozzle of the plurality is a fluidic nozzle.

13. The apparatus of claim 1, wherein the nozzles disperse steam in a first direction first and then a second direction.

14. The apparatus of claim 1, wherein the steam disperses on the object in the first and second direction for 3-10 seconds each.

15. The apparatus of claim 1, wherein the steam disperses on the object short enough such that the object is able to return to room temperature within 5 minutes.

16. The apparatus of claim 1, wherein steam is dispersed continuously.

17. The apparatus of claim 1, wherein the steam is pulsed.

18. The apparatus of claim 1, wherein the steam comprises a density of 0.1991304 g/ml or less.

19. The apparatus of claim 1, wherein the chamber is in communication with a centralized heated and pressurized water circulation system within a building and a valve controls the amount of fluid that reaches the nozzles.

20. The apparatus of claim 19, wherein the nozzles and the pressure associated with the water circulation system to create steam out of the fluid.
